(19) United States
(12) Patent Application Publication
(10) Pub. No.: US 2014/0152695 A1
(43) Pub. Date: Jun. 5, 2014

(54) DISPLAY DEVICE

(71) Applicant: Akio Ishiwata, Tokyo (JP)

(72) Inventor: Akio Ishiwata, Tokyo (JP)

(21) Appl. No.: 14/131,879

(22) PCT Filed: Jul. 12, 2011
(86) PCT No.: PCT/JP2011/065858

§ 371 Date: Jan. 9, 2014

(51) Int. Cl. G09G 5/14; G06T 3/60

(52) U.S. Cl. CPC G09G 5/14; G06T 3/60
USPC 345/629

(57) ABSTRACT

A display device includes: a first video signal input unit that receives a first video signal; a second video signal input unit that receives a second video signal; a video signal rotating unit that converts the first video signal so that an image based on the first video signal rotates, to obtain a converted video signal; a video combining unit that combines the second video signal with the first converted image signal to obtain a combined video image signal; and a display unit that displays a combined video image based on the combined image signal.

### TECHNICAL FIELD

The present invention relates to a display device that combines a sub screen in a main screen and displays the combined screen.

### BACKGROUND ART

Conventionally, a display device that can perform display by overlapping a small screen (sub screen) for displaying a reproduced image of an audio-visual device, in a display of a screen of a personal computer (referred to as “main screen”) has been known. FIG. 6 is a block diagram that depicts a configuration of a conventional display device. In FIG. 6, reference symbol 1 denotes a video signal input unit to which a main screen signal A is input, which is a signal of a video image to be displayed as a main screen. Reference symbol 2 denotes a video signal input unit to which a sub screen signal B is input, which is a signal of a video image to be displayed as a sub screen. Reference symbol 3 denotes a video combining unit to which video signals that have been inputted to the two video signal input units 1 and 2 are input, and which combines two video signals and outputs the combined video signal. Reference symbol 4 denotes a video display unit that displays a video image output from the video combining unit 3, thereby displaying a video image in which a sub screen is overlapped on a main screen. Thus, a reproduced video image of the audio-visual device (sub screen B) is displayed on the video display unit 4 at a right bottom part of the video image (main screen A) of a personal computer or the like.

Moreover, there has been known a display device in which a combined data signal including a video signal rotated 90 degrees is input to a vertically long display which is installed vertically long by rotating a horizontally long display 90 degrees, and can be displayed on the vertically long display (for example, refer to Patent Document 1).

### PRIOR ART DOCUMENTS

### Patent Document

Patent Document 1: Japanese Unexamined Patent Application, First Publication No. 2004-061562

### SUMMARY OF THE INVENTION

### Problem to be Solved by the Invention

Incidentally, a recent liquid-crystal display device includes a mechanism that changes over a horizontally long display panel to a vertically long state, so that it can be used in a horizontally long state or in a vertically long state according to an application.

However, in the conventional display device as shown in FIG. 6, the function of rotating the video image is not provided. Accordingly, if a display panel is mechanically rotated, there is a problem in that the display state shown in FIG. 7 (a) becomes a display mode as shown in FIG. 7 (b). When a screen of a personal computer is displayed on a main screen, a video image in the normal orientation can be displayed as shown in FIG. 7 (c) by rotating a video signal output from the personal computer 90 degrees clockwise and outputting the video signal. However, a sub screen for displaying a reproduced video image of the audio-visual device does not have the function of rotating the video image. Therefore there is still a problem in that the video image cannot be displayed in the normal orientation.

The present invention has been conceived in view of the above situation, and an object thereof is to provide in a display device that performs display in which a sub screen is overlapped on a main screen, a display device in which the orientation to display the sub screen can be made a normal state.

### Means for Solving the Problem

The present invention provides a display device including: a plurality of video signal input means; a video combining means that combines a plurality of video signals input from the video signal input means; and a display means that displays a combined video image by the video combining means, and the display device further includes a video signal rotating means that rotates orientations of images of the video signals input from the video signal input means, and the rotated video signals are combined by the video combining means and displayed on the display means.

The present invention may further includes a posture detecting means that detects a posture of the display means, and the video signal rotating means may detect orientations of the video signals, and rotate the orientations of the images of the video signals based on an output of the posture detecting means and a detection result of the orientation of the video signal.

In the present invention, the video signal rotating means performs coordinate transformation of rotating the orientations of the images of the video signals, so that a combined positional relation of the rotated video images becomes the same positional relation as the combined positional relation of the video images before rotation.

### Effect of the Invention

According to the present invention, there is the effect that the simultaneous display of a plurality of input video signals having different image orientations becomes possible, while the orientations thereof are unified.

### BRIEF DESCRIPTION OF THE DRAWINGS

FIG. 1 is a block diagram showing a configuration of a first exemplary embodiment of the present invention.

FIG. 2 is a diagram for explaining a display example when a screen is rotated.

FIG. 3 is a block diagram showing a configuration of a second exemplary embodiment of the present invention.

FIG. 4 is a block diagram showing a configuration of a third exemplary embodiment of the present invention.

FIG. 5 is a diagram for explaining a display example when a screen is rotated.

FIG. 6 is a block diagram showing a configuration of a display device according to a conventional art.

FIG. 7 is a diagram for explaining an orientation of a video image in a display device according to the conventional art.

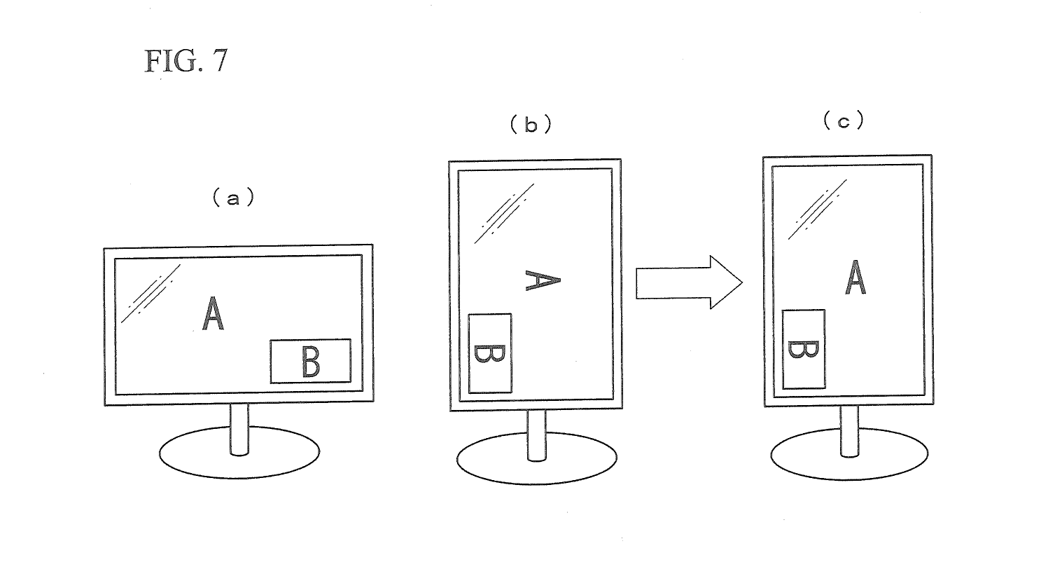

### EMBODIMENTS FOR CARRYING OUT THE INVENTION

### First Exemplary Embodiment

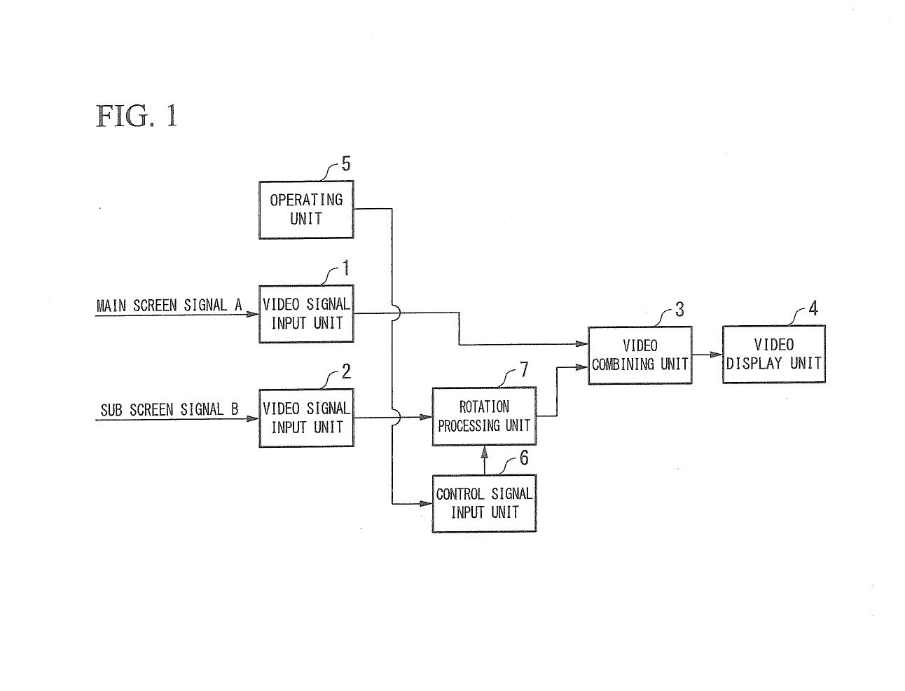

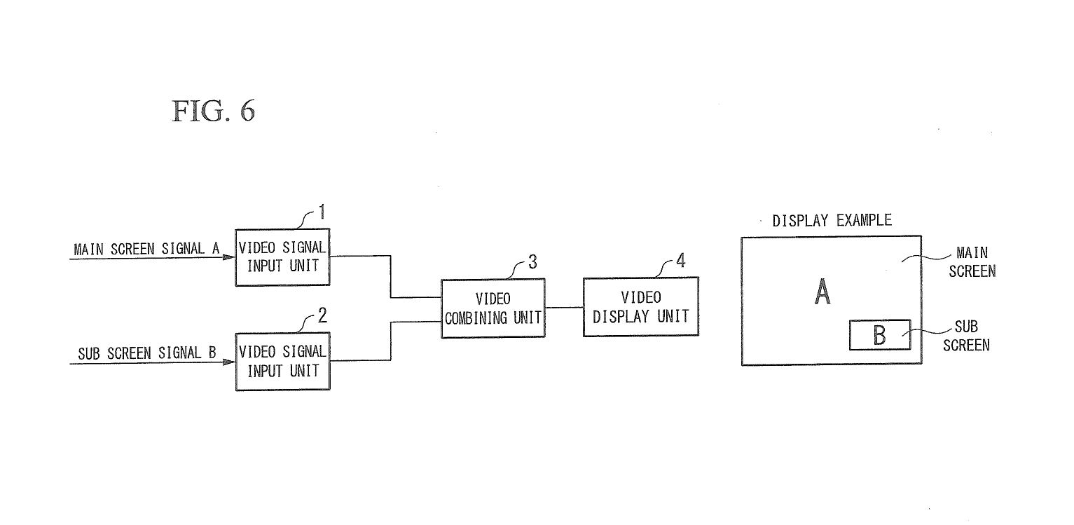

Hereunder is a description of a display device according to a first exemplary embodiment of the present invention, with reference to the drawings. FIG. 1 is a block diagram showing the configuration of this exemplary embodiment. In this figure, parts similar to those in the conventional device shown in FIG. 6 are denoted by the same reference symbols and description thereof is omitted. The device shown in this figure is different from the conventional device in that an operating unit 5, a control signal input unit 6, and a rotation processing unit 7 are newly provided. The operating unit 5 is constituted from a key switch and the like, and performs an operation to instruct to rotate a sub screen in a specified orientation. A control signal output from the operating unit 5 is inputted to control signal input unit 6 when an operation instruction is performed at the operating unit 5. A control signal is input to the rotation processing unit 7, which is a control signal from the operating unit 5 and is input to and output from the control signal input unit 6. The rotation processing unit 7 performs coordinate transformation of a video signal of a sub screen output from a video signal input unit 2 based on the control signal to perform a rotation process of a video image of the sub screen.

The control signal indicates an angle at which the video image is to be rotated. In the case of rotating 90 degrees counterclockwise, the control signal indicates “−90°”, and in the case of rotating 90 degrees clockwise, the signal indicates “90°”. Moreover, in the case of no rotation, the control signal indicates “0°”. The control signal input unit 6 holds the control signal output from the operating unit 5 and does not update the control signal until a new control signal is output from the operating unit 5. Consequently, the control signal output from the control signal input unit 6 to the rotation processing unit 7 is not updated as well until a new control signal is output from the operating unit 5, and the control signal immediately before is continuously output.

Next is a description of an operation of the display device shown in FIG. 1. Here, the description is made assuming that a signal of a screen of a personal computer is input as a main screen signal A, and a signal of a reproduced video image of an audio-visual device is input as a sub screen signal. B. The main screen signal A output from a personal computer or the like is input to a video signal input unit 1. In parallel therewith, the sub screen signal B output from the audio-visual device or the like is input to the video signal input unit 2. On the other hand, in an initial state, the operating unit 5 outputs “0°” as the control signal, and hence, the control signal input unit 6 outputs a control signal “0°” to the rotation processing unit 7.

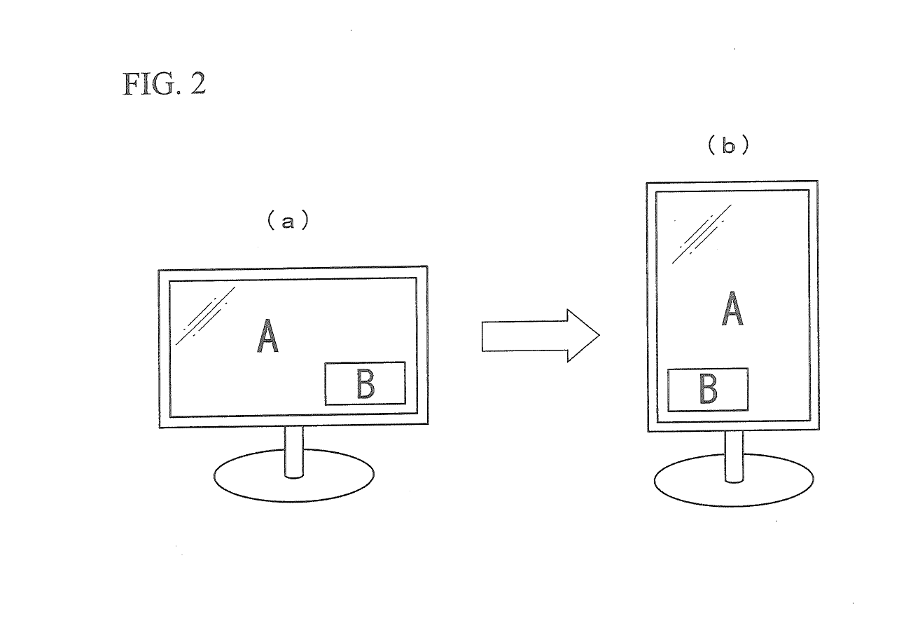

The video signal input unit 1 outputs the input signal to a video combining unit 3, and the video signal input unit 2 outputs the input signal to the rotation processing unit 7. The rotation processing unit 7 performs coordinate transformation of the sub screen signal B output from the video signal input unit 2 based on the control signal output from the control signal input unit 6, and outputs it. At this time, since the control signal “0°” has been input to the rotation processing unit 7, the rotation processing unit 7 outputs the sub screen signal B to the video combining unit 3 without performing the rotation process of the video image. The video combining unit 3 combines the input two screen signals (main screen signal A, sub screen signal B) and outputs it to a video display unit 4. As a result, a video image obtained by combining the sub screen on the main screen is displayed on the video display unit 4. FIG. 2 (a) shows a display example in which the sub screen for which the rotation process is not performed is overlapped on the main screen.

Next, a user rotates the video display unit 4 90 degrees clockwise and fixes the video display unit 4, and also performs an operation to instruct to rotate the screen 90 degrees via a personal computer. As a result, the main screen signal A rotated 90 degrees is output from the personal computer, and the main screen signal A is input to the video signal input unit 1. Moreover, the user performs an operation to instruct to rotate the sub screen −90 degrees via the operating unit 5. The video signal input unit 2 receives the input of the sub screen signal B and outputs it to the rotation processing unit 7. The control signal input unit 6 receives the input of the control signal output from the operating unit 5, and outputs the input control signal to the rotation processing unit 7.

The rotation processing unit 7 receives the input of the sub screen signal B output from the video signal input unit 2, performs coordinate transformation of the input sub screen signal B based on the control signal (−90°) output from the control signal input unit 6, and outputs, to the video combining unit 3, the sub screen signal B with the sub screen rotated −90 degrees. The video combining unit 3 combines the main screen signal A output from the video signal input unit 1 with the sub screen signal B output from the rotation processing unit 7, and outputs it to the video display unit 4. Consequently, a video image in which the −90 degrees rotated sub screen is combined in the main screen is displayed on the video display unit 4 rotated 90 degrees. FIG. 2 (b) shows a display example in which the rotated sub screen is overlapped on the main screen.

### Second Exemplary Embodiment

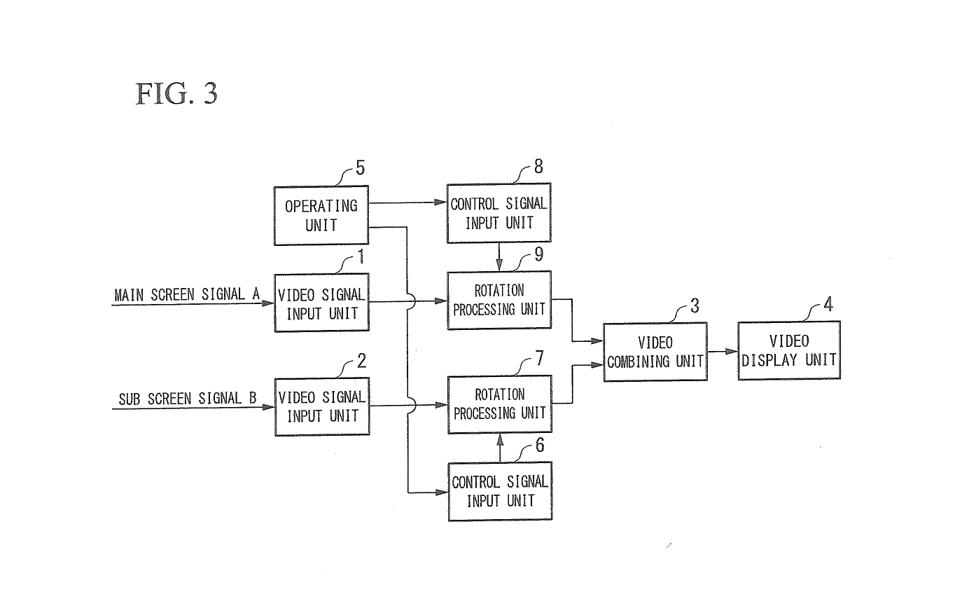

Next is a description of a display device according to a second exemplary embodiment of the present invention. FIG. 3 is a block diagram showing the configuration of this embodiment of the present invention. In this figure, parts similar to those in the device shown in FIG. 1 are denoted by the same reference symbols, and description thereof is omitted. The device shown in this figure is different from the device shown in FIG. 1 in that a control signal input unit 8 and a rotation processing unit 9 are further provided. The control signal input unit 8 performs the same processing as that of a control signal input unit 6. Also, the rotation processing unit 9 performs the same processing as that of a rotation processing unit 7.

Next is a description of an operation of the display device shown in FIG. 3. When a video display unit 4 is not rotated, the two rotation processing units 7 and 9 do not perform the rotation process with respect to the signals output from two video signal input units 1 and 2 and directly output the signals to a video combining unit 3. Therefore, detailed description of the procedure is omitted.

When the video display unit 4 is rotated 90 degrees clockwise, a user performs an operation to instruct to rotate the sub screen and the main screen respectively −90 degrees via the operating unit 5. The control signal input unit 6 receives the input of a control signal output from the operating unit 5, and outputs the input control signal to the rotation processing unit 7. Moreover, the control signal input unit 8 receives the input of a control signal output from the operating unit 5, and outputs the input control signal to the rotation processing unit 9.

The rotation processing unit 7 receives the input of a sub screen signal B output from the video signal input unit 2, performs coordinate transformation of the input sub screen signal B based on the control signal (−90°) output from the control signal input unit 6, and outputs, to the video combining unit 3, the sub screen signal B with the sub screen rotated −90 degrees. Moreover, the rotation processing unit 9 receives the input of a main screen signal A output from the video signal input 1, performs coordinate transformation of the input main screen signal A based on the control signal (−90°) output from the control signal input unit 8, and outputs, to the video combining unit 3, the main screen signal A with the main screen rotated −90 degrees.

The video combining unit 3 combines the main screen signal A output from the rotation processing unit 9 with the sub screen signal B output from the rotation processing unit 7, and outputs it to the video display unit 4. Consequently, a video image in which the −90 degrees rotated sub screen is combined with the −90 degrees rotated main screen is displayed on the video display unit 4 rotated 90 degrees. As a result, a combined video image shown in FIG. 2 (b) is displayed.

### Third Exemplary Embodiment

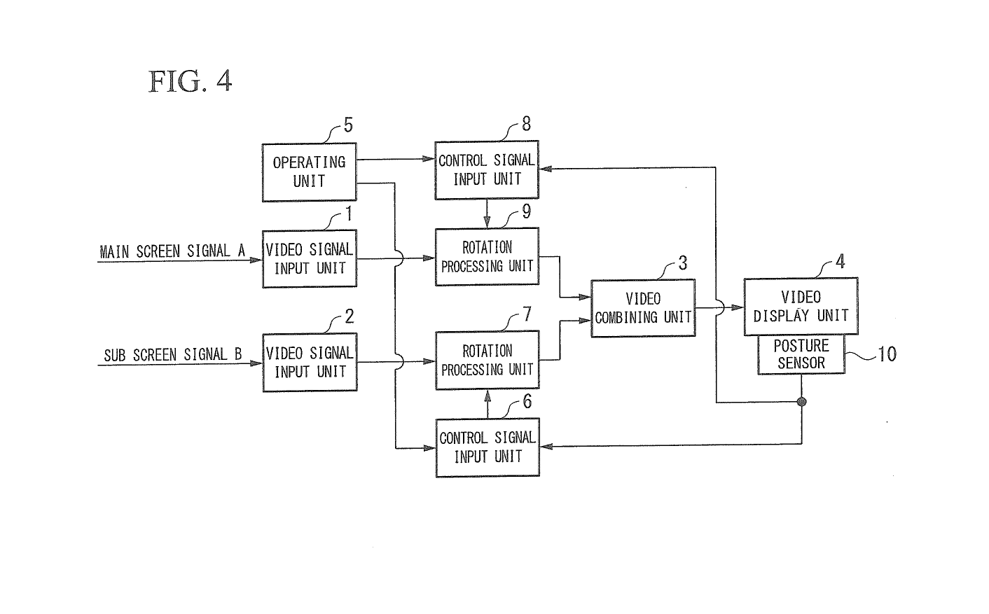

Next is a description of a display device according to a third exemplary embodiment of the present invention. FIG. 4 is a block diagram showing the configuration of this embodiment. In this figure, parts similar to those in the device shown in FIG. 3 are denoted by the same reference symbols, and description thereof is omitted. The device shown in this figure is different from the device shown in FIG. 3 in that a posture sensor 10 that detects the posture of the video display unit 4 is provided to the video display unit 4, and an output of the posture sensor 10 is output to control each of the signal input units 6 and 8. The operating unit 5 that outputs a control signal which is input to the two control signal input units 6 and 8, need not necessarily be provided.

Next is a description of an operation of the display device shown in FIG. 4. The posture sensor 10 detects the posture of the video display unit 4, and outputs posture information as a detection result to the two control signal input units 6 and 8. The posture information is information capable of determining whether the posture of the video display unit 4 is in a non-rotated state (0°), in a state rotated 90 degrees clockwise (90°), or in a state rotated counterclockwise (−90°). The control signal input units 6 and 8 respectively output a control signal (any of 0°, 90°, or −90°) to the rotation processing units 7 and 9 based on the posture information output from the posture sensor 10. The rotation processing units 7 and 9 respectively receive the input of a video signal output respectively from video signal input units 2 and 1, and detect orientation information of a video signal from the input video signal (the rotation processing unit 9 detects orientation information from a main screen signal A, and the rotation processing unit 7 detects orientation information from a sub screen signal B). The orientation information of the video signal is information indicating (0°) if a rotation process is not performed with respect to the video signal, information indicating (90°) if the rotation process for rotating the video signal 90 degrees clockwise is performed, and information indicating (−90°) if the rotation process for rotating the video signal 90 degrees counterclockwise is performed.

The rotation processing unit 9 receives the input of the main screen signal A output from the video signal input unit 1, and detects orientation information of the main screen signal A from the input main screen signal A. Furthermore, the rotation processing unit 9 receives the input of a control signal output from the control signal input unit 8, and determines whether the detected orientation information of the main screen signal A matches with the orientation of the video display unit 4 indicated by the control signal, and if the orientation information matches with the orientation of the video display unit 4, outputs the input main screen signal A to a video combining unit 3 without performing a rotation process. On the other hand, if the detected orientation information of the main screen signal A does not match with the orientation of the video display unit 4 indicated by the control signal, the rotation processing unit 9 performs the rotation process so that the main screen is displayed on the current video display unit 4 in the correct orientation, and outputs it to the video combining unit 3.

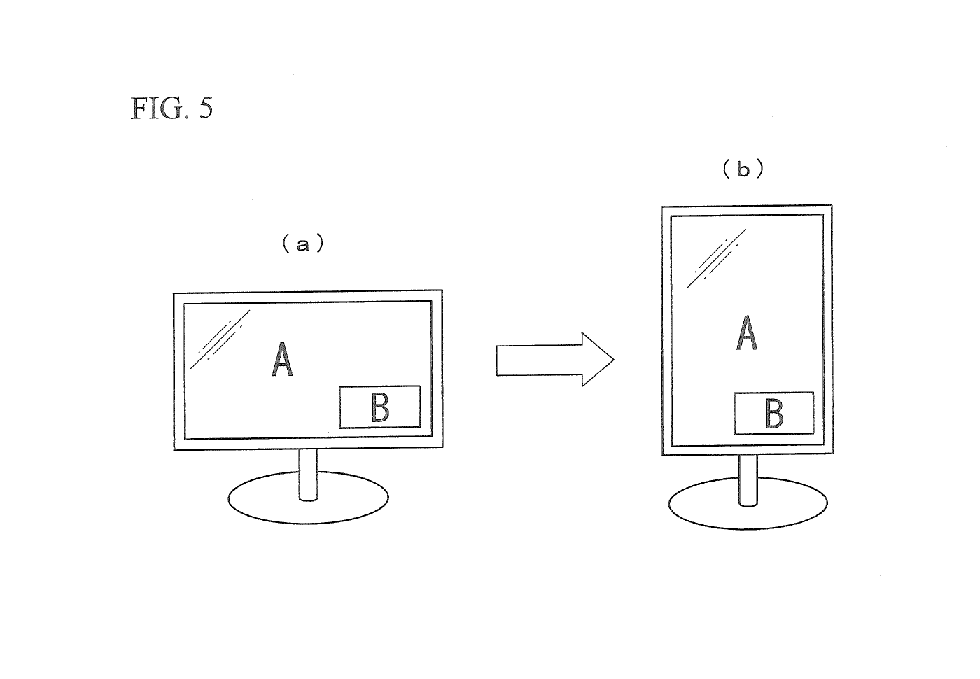

Moreover, the rotation processing unit 7 receives the input of the sub screen signal B output from the video signal input unit 2, and detects orientation information of the sub screen signal B from the input sub screen signal B. The rotation processing unit 7 receives the input of the control signal output from the control signal input unit 6 to determine whether the detected orientation information of the sub screen signal B matches with the orientation of the video display unit 4 indicated by the control signal, and if the orientation information matches with the orientation of the video display unit 4, outputs the input sub screen signal B to the video combining unit 3 without performing the rotation process. On the other hand, if the detected orientation information of the sub screen signal B does not match with the orientation of the video display unit 4 indicated by the control signal, the rotation processing unit 7 performs the rotation process by coordinate transformation so that the sub screen is displayed on the current video display unit 4 in the correct orientation, and outputs it to the video combining unit 3. At this time, the rotation processing unit 7 detects to which corner, of four corners of the video display unit 4, a display position of the sub screen is closest in the sub screen signal B output from the video signal input unit 2, and performs coordinate transformation so that the position of the sub screen after the rotation process is at the same position as the corner closest to the sub screen before the rotation process. In an example shown in FIG. 5, because the sub screen before the rotation process (FIG. 5 (a)) is displayed at a position close to the right bottom corner, coordinate transformation is performed so that the sub screen after the rotation process (FIG. 5 (b)) is also displayed at a position close to the right bottom corner. By so doing, the sub screen can be displayed at the same position as seen from a user at all times.

In the above description, the number of sub screens to be combined with the main screen is one. However, the configuration may be such that two or more sub screens are combined. In this case, the control signal input units and the rotation processing units of the same number as that of the sub screens need only to be provided.

As described above, in the display device that can simultaneously display two or more video images as the main screen and the sub screens when two or more video images are simultaneously input, a function of rotating the main screen and the sub screen individually is provided. Accordingly, for example, a horizontal input image and a vertical input image can be simultaneously displayed in the correct orientation on one display device.

A program for realizing the function of the rotation processing unit in. FIG. 1, FIG. 3, and FIG. 4 may be recorded in a computer-readable recording medium, and the program recorded in the recording medium may be read and executed by a computer system, thereby enabling to perform the rotation process of the input video image. The “computer system” referred to herein includes an OS and hardware such as peripheral devices. Moreover, the “computer-readable recording medium” refers to a portable medium such as a flexible disk, a magneto-optical disk, a ROM, and a CD-ROM, or a storage device such as a hard disk incorporated in a computer system. Furthermore, the “computer-readable recording medium” includes one that holds a program for a certain period of time, such as a volatile memory (RAM) in a computer system, which becomes a server or a client when the program is transmitted via a network such as the Internet or a communication line such as a telephone line.

Moreover, the program may be transmitted from a computer system in which the program is stored in a storage device or the like to another computer system via a transmission medium or by a carrier wave in the transmission medium. The “transmission medium” that transmits the program refers to a medium having a function of transmitting information such as a network (communication network) such as the Internet and a communication line (communication wire) such as a telephone line. Furthermore, the program may be one that realizes a part of the functions described above. Moreover it may be one that can realize the functions described above by being combined with a program already recorded in the computer system, that is, may be a so-called difference file (difference program).

### INDUSTRIAL APPLICABILITY

A display device that combines a video image of a sub screen with a video image of a main screen can be applied to an application in which it is essential to display a screen of the display device by rotating the screen.

### REFERENCE SYMBOLS

1, 2 Video signal input unit
3 Video combining unit
4 Video display unit
5 Operating unit
6, 8 Control signal input unit
7, 9 Rotation processing unit
10 Posture sensor

1. A display device comprising:
a first video signal input unit that receives a first video signal;
a second video signal input unit that receives a second video signal;
a video signal rotating unit that converts the first video signal so that an image based on the first video signal rotates, to obtain a converted video signal;
a video combining unit that combines the second video signal with the first converted image signal to obtain a combined video image signal; and
a display unit that displays a combined video image based on the combined image signal.

2. The display device according to claim 1, further comprising:
a posture detecting unit that detects a posture of the display unit,
wherein the video signal rotating unit detects an orientation of the image based on the first video signal, and converts the first video signal based on the detected posture and the detected orientation.

3. The display device according to claim 1, wherein the video signal rotating unit converts a coordinate of the image based on the first video signal so that a display position of an image based on the converted image signal is substantially the same as a display position of the image based on the first image signal when seen from a user.
